(19) United States
(12) Patent Application Publication
(10) Pub. No.: US 2017/0176932 A1
(43) Pub. Date: Jun. 22, 2017

(54) HOLOGRAPHIC DISPLAY DEVICE USING ILLUMINATION LIGHT OF WHICH BEAM SHAPE IS ADJUSTED

(71) Applicant: ELECTRONICS AND TELECOMMUNICATIONS RESEARCH INSTITUTE, Daejeon (KR)

(72) Inventors: Min Sung YOON, Daejeon (KR); Kwan Jung OH, Daejeon (KR)

(21) Appl. No.: 15/381,002

(22) Filed: Dec. 15, 2016

(30) Foreign Application Priority Data
Dec. 18, 2015 (KR) 10-2015-0182035
May 3, 2016 (KR) 10-2016-0054868

(51) Int. Cl. G03H 1/22; F21V 8/00; G02B 27/09

(52) U.S. Cl. CPC G03H 1/2286; G03H 1/2294; G02B 27/0927; G02B 6/0035; G03H 2222/35; G03H 2222/54; G03H 2223/16; G03H 2223/17

(57) ABSTRACT

Provided/Disclosed is a holographic display device including a light source configured to output a coherent emission beam, a beam illuminator configured to convert the emission beam to an illumination light having a plane wavefront and a spatially regular intensity and output the converted emission beam, and a spatial light modulator (SLM) configured to display a holographic image by modulating the illumination light based on image information, wherein the beam illuminator is configured to converge and output the illumination light.

### CROSS-REFERENCE TO RELATED APPLICATION(S)

This application claims the priority benefit of Korean Patent Application No. 10-2015-0182035 filed on Dec. 18, 2015, in the Korean Intellectual Property Office, and Korean Patent Application No. 10-2016-0054868 filed on May 3, 2016, in the Korean Intellectual Property Office, the disclosures of which are incorporated herein by reference for all purposes.

### BACKGROUND

1. Field

One or more example embodiments relate to a holographic display device and method using illumination light of which a beam shape is adjusted.

2. Description of Related Art

Holographic display technology is a three-dimensional (3D) display technology for intactly displaying a wavefront generated by an object based on diffraction of light and an interference characteristic to provide an effect of making an object appear to actually exist, for people to experience.

Unlike the conventional stereo technology mostly used in the 3D display industry, the holographic display technology may not cause eye fatigue and dizziness because an image generated by the holographic display technology has no accommodation-convergence mismatch. The holographic display technology may enable a plurality of users to view a 3D image without an additional viewing device, for example, 3D glasses, and view different images based on a viewpoint.

However, current technology is unable to provide an ideal holographic display and thus, a new holographic display system for combining a display device or a commercial display with optical and mechanical machines is being developed.

A viewing window based holographic display is one of holographic display technologies currently being developed. The viewing window based holographic display is display technology used for viewing a large holographic image from a predetermined position through a display panel of which a pixel size is relatively large by allowing diffracting lights to be concentrated into a limited area. Even though the holographic display uses a coherent illumination light, such as a laser, it may be dangerous for a user if the illumination light is directly incident on the user for a long time. Thus, the coherent illumination light is required to have a regular optimal intensity and to be output to an active area of a spatial light modulator (SLM) to which a holographic image is encoded.

The conventional viewing window based holographic display device may include, in front, an illuminator to provide parallel straightness and expandability of a beam based on an SLM, and a field lens corresponding to a beam converger additionally disposed in back of the SLM.

Since the SLM is disposed between the illuminator and the beam converger, an additional control process, such as a process for disposing optical components and an arrangement process involved in a direction of a beam based on a characteristic of a light path with respect to each of the illuminator and the beam converger disposed in front and back of the SLM is requested. In addition, the holographic display device may be thick because components included in the illuminator and the beam converger may take up much volume. Manufacturing cost may increase because extra components are required for fixing and accurately arranging the illuminator and the beam converger.

Thus, a holographic display device including a flat plate type illumination optical device having a display active area and being thin and light weight has been requested.

### SUMMARY

An aspect provides a holographic display device that is slimmer than the conventional holographic display device regardless of a type of a display by using a beam illuminator having a light collecting function combined with a converging function associated with an illumination light such that the beam illuminator is appropriate for a viewing window based flat plate type holographic display.

According to an aspect, there is provided a holographic display device including a light source configured to output a coherent emission beam, a beam illuminator configured to convert the emission beam to an illumination light having a plane wavefront and a spatially regular intensity and output the converted emission beam, and a spatial light modulator (SLM) configured to display a holographic image by modulating the illumination light based on image information, wherein the beam illuminator is configured to converge and output the to illumination light.

The beam illuminator of the holographic display device may include a condenser configured to convert the emission beam to the illumination light having the plane wavefront and the spatially regular intensity, a light guiding plate on which the illumination light is incident, and a field lens configured to converge the illumination light output by the light guiding plate and transmit the illumination light to the SLM.

The light guiding plate of the holographic display device may include a first grating pattern to guide the illumination light emitted to an incident surface of the light guiding plate along a path such that the illumination light is incident in a longitudinal direction of the light guiding plate and the illumination light is output in a direction including an active area of the field lens.

The first grating pattern of the holographic display device may guide the illumination light along the path such that the illumination light is incident at an angle including an active area of the SLM in the longitudinal direction of the light guiding plate.

The first grating pattern of the holographic display device may be formed by an arranged structure of regular slits or material of which a refractive index is periodically changed.

The light guiding plate of the holographic display device may include an incident surface that is coated using an anti-reflective coating technique when an incident angle of the illumination light is greater than or equal to a preset angle.

The field lens of the holographic display device may include a second grating pattern to guide the illumination light output from the light guiding plate and emitted to an incident surface of the field lens along a path such that the illumination light is extended vertically in a longitudinal direction of a column of the light guiding plate, and a third grating pattern to guide the illumination light output from an output surface of the field lens along the path such that the illumination light converges based on a preset focal distance.

The illumination light extended vertically may be vertically incident on the output surface of the field lens.

The field lens of the holographic display device may include an incident surface that is coated using an anti-reflective coating technique when an incident angle of the illumination light is greater than or equal to a preset angle.

The second grating pattern and the third grating pattern may be formed by an arranged structure of regular slits or material of which a refractive index is periodically changed.

The beam illuminator may be disposed in a location in which the illumination light has a regular light intensity and a feature of a plane wave field extended to be a size corresponding to an active area of the SLM at a point in time at which the illumination light is incident on the SLM.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a holographic display device according to an example embodiment;

FIG. 2 illustrates a beam illuminator according to an example embodiment;

FIG. 3 illustrates a light path of an illumination light in a holographic display device according to an example embodiment;

FIGS. 4A and 4B illustrate example implementations of an illumination light according to an example embodiment;

FIG. 5 illustrates a holographic display device according to an example embodiment;

FIG. 6 illustrates a structure of a grating pattern according to an example embodiment; and

FIG. 7 is a graph illustrating diffraction efficiency measurement according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

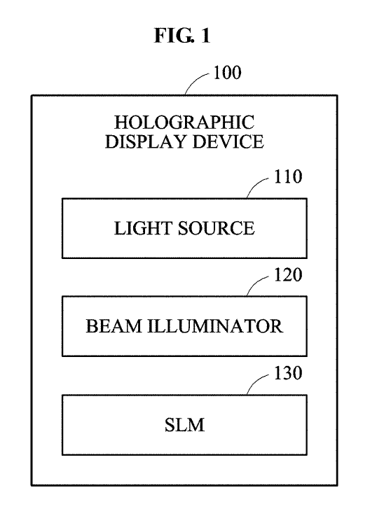

FIG. 1 is a block diagram illustrating a holographic display device according to an example embodiment.

Referring to FIG. 1, a holographic display device 100 includes a light source 110, a beam illuminator 120, and a spatial light modulator (SLM) 130.

The light source 110 outputs a coherent emission beam. Here, the emission beam may be a coherent incident wave field.

The beam illuminator 120 converts the emission beam output by the light source 110 to an illumination light having a plane wavefront and a spatially regular intensity, and outputs the converted emission beam. The beam illuminator 120 may adjust a beam shape of the illumination light, and converge and output the illumination light to the SLM 130. The illumination light may be a light of which a size of a wave field is extended to be greater than the emission beam.

In addition, the beam illuminator 120 includes a condenser to convert the emission beam to the illumination light having the plane wavefront and the spatially regular intensity, a light guiding plate on which the illumination light is incident, and a field lens to converge the illumination light output by the light guiding plate and transmit the illumination light to the SLM 130.

The light guiding plate includes a first grating pattern to guide the illumination light emitted to an incident surface of the light guiding plate along a path such that the illumination light is incident in a longitudinal direction of the light guiding plate and the illumination light is output in a direction including an active area of the field lens. Here, the longitudinal direction may refer to a direction of a tall or wide square shaped column in the light guiding plate.

The first grating pattern guides the illumination light along the path such that the illumination light is incident at an angle including an active area of the SLM 130 in the longitudinal direction of the light guiding plate. In addition, the first grating pattern is formed by an arranged structure of regular slits or material of which a refractive index is periodically changed.

The light guiding plate may include the incident surface that is coated using the anti-reflective coating technique when an incident angle of the illumination light is greater than or equal to a preset angle.

The field lens includes a second grating pattern to guide the illumination light output from the light guiding plate and emitted to the incident surface of the field lens along a path such that the illumination light is extended vertically in the longitudinal direction of a column of the light guiding plate, and a third grating pattern to guide the illumination light output from an output surface of the field lens along the path such that the illumination light converges based on a preset focal distance. Here, the illumination light extended vertically may be vertically incident on the output surface of the field lens and has a form of a two-dimensional (2D) plane corresponding to the active area.

The second grating pattern and the third grating pattern are formed by the arranged structure of regular slits or the material of which the refractive index is periodically changed.

The field lens may include the incident surface that is coated using the anti-reflective coating technique when the incident angle of the illumination light is greater than or equal to the preset angle.

The beam illuminator 120 is disposed in a location in which the illumination light has a regular light intensity and a feature of a plane wave field extended to be a size corresponding to an active area of the SLM 130 at a point in time at which the illumination light is incident on the SLM 130.

The SLM 130 displays the holographic image by modulating the illumination light based on image information. The SLM 130 may be a flat plate type liquid crystal display (LCD) panel and have a pixel pitch ranging from several μm to several hundred μm.

The holographic display device 100 may be slimmer than the conventional holographic display device regardless of a type of a display because it uses the beam illuminator 120 having a light collecting function combined with a converging function associated with the illumination light such that the holographic display device 100 is appropriate for a viewing window based flat plate type holographic display.

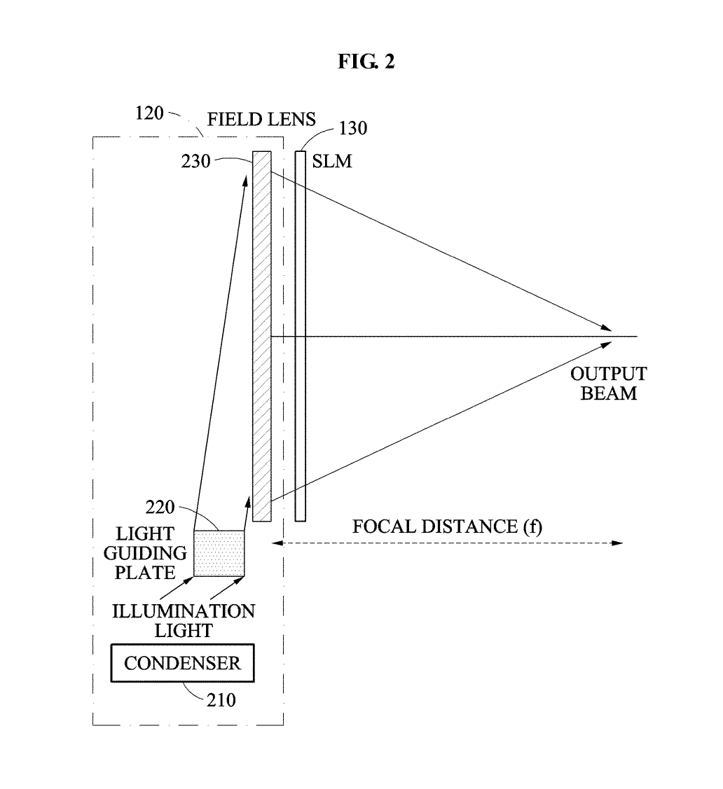

FIG. 2 illustrates a beam illuminator according to an example embodiment.

When a wavelength of an emission beam output by the light source 110 is λ, a pixel pitch of the SLM 130 is p, and a focal distance of a field lens 230 included in the beam illuminator is f, a size W of a viewing window formed by an output beam may be determined to be W=λf/p. For example, when the focal distance is 50 cm, the pixel pitch is 50 um, and the wavelength of the emission beam is 532 nm (green wavelength), the size W of the viewing window may be 5.32 mm.

A condenser 210 may infuse the emission beam to an inside of a light guiding plate 220 by converting the emission beam to an illumination light having a plane wavefront and a spatially regular intensity. Based on a refractive index n_{A} of the light guiding plate 220 and a refractive index n₀=1 of air, a relationship between a first incident angle Φ and a refraction angle θ of the illumination light to be incident on the light guiding plate 220 may be sin Φ=n_{A} sin θ.

An output surface of the light guiding plate 220 may include a first grating pattern to guide the illumination light emitted through the output surface of the light guiding plate 220 along a path such that the illumination light is output in a direction including an active area of the field lens 230. Thus, the illumination light incident on the light guiding plate 220 may be extended through the output surface in a longitudinal direction of the light guiding plate 220, and may be incident on the field lens 230.

The incident surface of the field lens 230 may include a second grating pattern to guide the illumination light incident on the incident surface of the field lens 230 along the path such that the illumination light is extended vertically in the longitudinal direction of a column of the light guiding plate 220. The illumination light incident on the field lens 230 may be extended, by the second grating pattern, in a form of a 2D plane corresponding to the active area in the field lens 230.

In addition, the illumination light extended in the form of the 2D plane may be vertically incident on the output surface of the field lens 230. The output surface of the field lens 230 may include a third grating pattern to guide the illumination light extended in the form of the 2D plane along the path such that the illumination light converges towards a preset focal distance.

The field lens 230 may include the second grating pattern and the third grating pattern, and the illumination light of which a beam shape is extended in the form of the 2D plane in the second grating pattern may be vertically incident on the third grating pattern. Thus, the field lens 230 may have a flat plate type structure of regular thickness, as illustrated in FIG. 2.

The field lens 230 may include the second grating pattern and the third grating pattern and thus, it is possible to have a geometric flat plate type structure in which a beam guiding function that allows a refractive index to be identical using the second grating pattern is integrally combined with a beam converging function using the third grating pattern.

A thickness of a dielectric medium of the light guiding plate 220 and the field lens 230 may be less than a few millimeters respectively.

The beam illuminator 120 may integrally include the light guiding plate 220 and the field lens 230, and the light guiding plate 220 and the field lens 230 may include the dielectric medium of which a value of the refractive index is regular. Thus, a problem of light loss caused by reflection of light that passes through a boundary surface formed by an air gap between light guiding plates included in the conventional holographic display device may be solved.

Because the beam illuminator 120 integrally includes the light guiding plate 220 and the field lens 230, a detailed alignment process may not be required unlike in the conventional holographic display device when relative positions of the conventional optical components are changed.

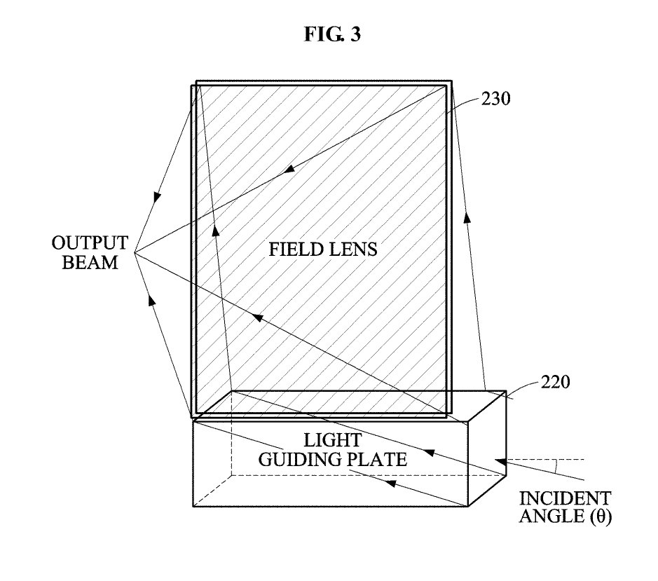

FIG. 3 illustrates a light path of an illumination light in a holographic display device according to an example embodiment.

As illustrated in FIG. 3, the light guiding plate 220 may allow an illumination light incident from a side of the field lens 230 to be incident on an incident surface of the field lens 230 through an output surface.

The incident surface of the field lens 230 may be a back surface of the field lens 230. A second grating pattern included in the incident surface of the field lens 230 may guide the illumination light along a path such that the illumination light is extended vertically in a longitudinal direction of the light guiding plate 220. Thus, the illumination light output by the light guiding plate 220 may be incident on a front surface of the field lens 230.

The output surface being the front surface of the field lens 230 may include a third grating pattern to guide the illumination light output from the field lens 230 along the path such that the illumination light converges towards a preset focal distance.

Thus, an output beam output from the field lens 230 may converge on a predetermined area as illustrated in FIG. 3.

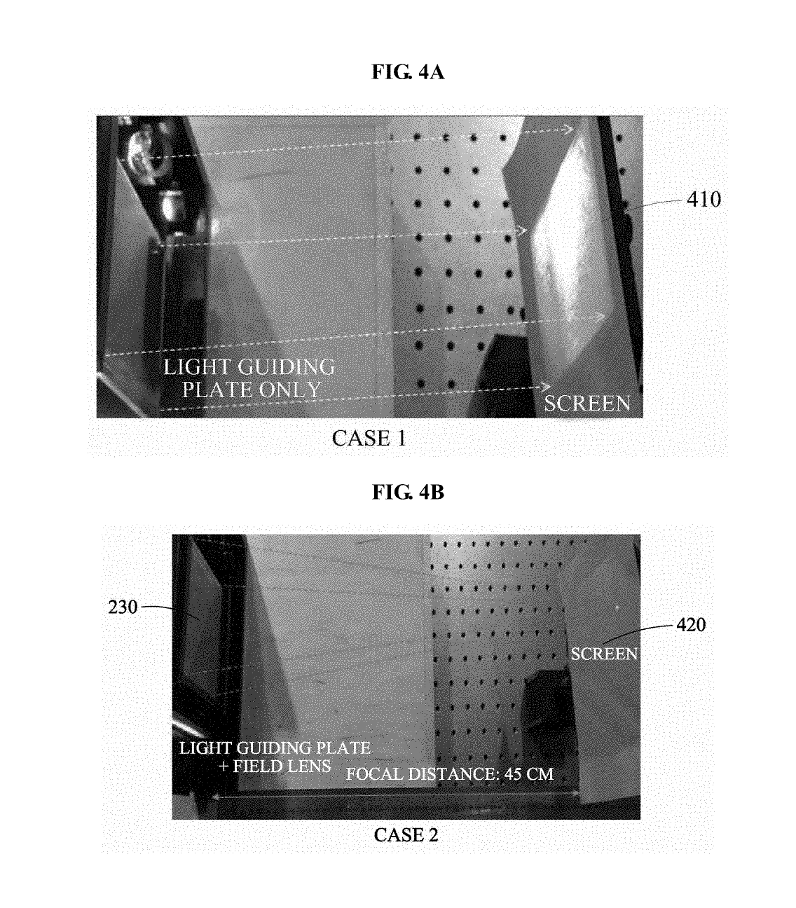

FIGS. 4A and 4B illustrate example implementations of an illumination light according to an example embodiment.

Case 1 of FIG. 4A is an example of an output beam output by the conventional holographic display device only including a light guiding plate. The output beam 410 may not converge as illustrated in FIG. 4A.

Case 2 of FIG. 4B is an example of an output beam 420 output by the holographic display device 100 integrally including the light guiding plate 220 and the field lens 230. The output beam 420 may converge on a predetermined area as illustrated in FIG. 4B.

FIG. 5 illustrates an example in which the holographic display device 100 displays a cube shape and a cone shape that represent different depth values.

An emission beam output by a laser light illuminator 510 may be converted to an illumination light having a plane wavefront and a spatially regular intensity, and then may be incident on a field lens 530 based on a light wave guide of a light guiding plate 520. The field lens 530 may allow the incident illumination light to converge on a predetermined area. Here, the illumination light output by the field lens 530 may transmit a spatial light modulator (SLM) 540, and the SLM 540 may modulate the transmitted illumination light based on image information and display the cube shape and the cone shape as illustrated in FIG. 5.

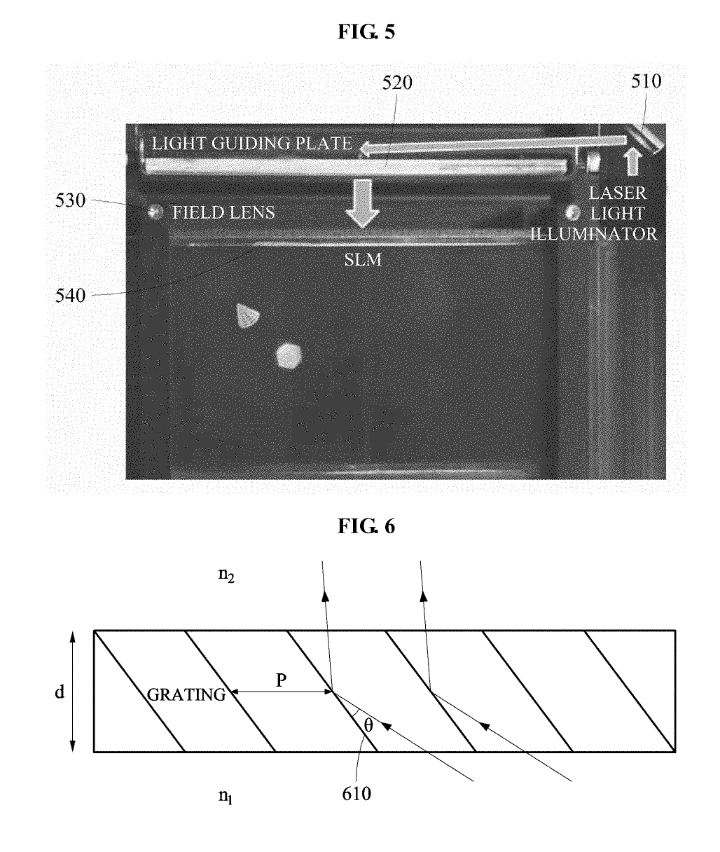

FIG. 6 illustrates a structure of a grating pattern according to an example embodiment.

A first grating pattern, a second grating pattern, and a third grating pattern included in the holographic display device 100 are provided by transmission type gratings, and may each be formed by an arranged structure of regular slits or material of which a refractive index is periodically changed.

For example, a transmission type grating having a thickness d, of which the refractive index is periodically changed may have a structure identical to that illustrated in FIG. 6. With respect to a normal line of a plane of a grating of which a pitch is P, each of an incident angle θ₁ and a refraction angle θ₂ may be determined to be θ=θ₁=θ₂ based on a law of reflection. When a refractive index of a grating is n, a refractive index of a sub-grating medium and a refractive index of an upper-grating medium may be n₁and n₂, respectively.

A progress direction of a transmitted light that passes through the transmission type grating may be determined using a relationship equation

$$sin θ = \frac{λ}{2 P}$$

by Brigg grating diffraction condition.

Thus, an invisible type grating may be designed based on an incident angle, grating direction adjustment, and a grating cycle, such that the transmitted light that passes through the transmission type grating may be directed and guided in a desired direction.

Further, an energy efficiency of the transmission type grating having the sufficient thickness d, for example, 10 um, may be relatively high, because a diffraction efficiency of the transmitted light is greater than or equal to 80%. In addition, because angular selectivity is relatively high, a coherent characteristic required for the holographic display device 100 may be secured.

Thus, the holographic display device 100 may use the transmission type grating of which the refractive index is periodically changed, the transmission type grating may provide the high angular selectivity and the optimal diffraction efficiency for the beam illuminator 120 corresponding to a device for controlling a beam shape.

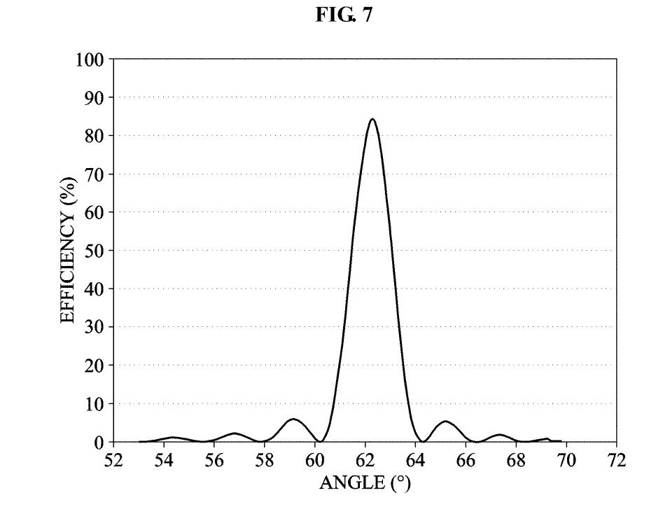

FIG. 7 is a graph illustrating diffraction efficiency measurement based on an incident angle in a transmission type grating pattern as illustrated in FIG. 6. Referring to FIG. 7, the transmission type grating pattern included in the holographic display device 100 may have a diffraction efficiency greater than or equal to 80% within a narrow angular range, for example, 1°, with respect to an angle of an incident beam of which a wavelength is 532 nm.

According to example embodiments of the present invention, it is possible that a holographic display device is slimmer than the conventional holographic display device regardless of display type by using a beam illuminator having a light collecting function combined with a converging function associated with an illumination light such that the holographic display device is appropriate for a viewing window based flat plate type holographic display.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A holographic display device comprising:
a light source configured to output a coherent emission beam;
a beam illuminator configured to convert the emission beam to an illumination light having a plane wavefront and a spatially regular intensity and output the converted emission beam; and
a spatial light modulator (SLM) configured to display a holographic image by modulating the illumination light based on image information,
wherein the beam illuminator is configured to converge and output the illumination light.

2. The holographic display device of claim 1, wherein the beam illuminator comprises:
a condenser configured to convert the emission beam to the illumination light having the plane wavefront and the spatially regular intensity;
a light guiding plate on which the illumination light is incident; and
a field lens configured to converge the illumination light output by the light guiding plate and transmit the illumination light to the SLM.

3. The holographic display device of claim 2, wherein the light guiding plate comprises a first grating pattern to guide the illumination light emitted to an incident surface of the light guiding plate along a path such that the illumination light is incident in a longitudinal direction of the light guiding plate and the illumination light is output in a direction including an active area of the field lens.

4. The holographic display device of claim 3, wherein the first grating pattern guides the illumination light along the path such that the illumination light is incident at an angle including an active area of the SLM in the longitudinal direction of the light guiding plate.

5. The holographic display device of claim 3, wherein the first grating pattern is formed by an arranged structure of regular slits or material of which a refractive index is periodically changed.

6. The holographic display device of claim 2, wherein the field lens comprises:
a second grating pattern to guide the illumination light output from the light guiding plate and emitted to an incident surface of the field lens along a path such that the illumination light is extended vertically in a longitudinal direction of a column of the light guiding plate; and
a third grating pattern to guide the illumination light output from an output surface of the field lens along the path such that the illumination light converges based on a preset focal distance.

7. The holographic display device of claim 6, wherein the illumination light extended vertically is vertically incident on the output surface of the field lens.

8. The holographic display device of claim 6, wherein the second grating pattern and the third grating pattern are formed by an arranged structure of regular slits or material of which a refractive index is periodically changed.

9. The holographic display device of claim 1, wherein the beam illuminator is disposed in a location in which the illumination light has a regular light intensity and a feature of a plane wave field extended to be a size corresponding to an active area of the SLM at a point in time at which the illumination light is incident on the SLM.
